(19) United States
(12) Patent Application Publication
(10) Pub. No.: US 2017/0220275 A1
(43) Pub. Date: Aug. 3, 2017

(54) COMPUTER SYSTEM AND MANAGEMENT PROGRAM

(71) Applicant: HITACHI, LTD., Tokyo (JP)

(72) Inventors: Takeshi ANZAI, Tokyo (JP); Norihiro KOBAYASHI, Tokyo (JP); Takahiko TOMIDA, Tokyo (JP); Shoichi YOKOYAMA, Tokyo (JP)

(73) Assignee: HITACHI, LTD., Tokyo (JP)

(21) Appl. No.: 15/328,076

(22) PCT Filed: Dec. 26, 2014
(86) PCT No.: PCT/JP2014/084580

§ 371 Date: Jan. 23, 2017

(51) Int. Cl. G06F 3/06

(52) U.S. Cl. CPC G06F 3/0619; G06F 3/061; G06F 3/0629; G06F 3/065; G06F 3/0673

(57) ABSTRACT

An administrator executes provisioning of a volume that satisfies a reliability requirement without being aware of storage configuration. A third processing module is configured to acquire a provisioning request that includes a reliability requirement for reliability of a storage service provided from a first processing module to a second processing module, and a volume requirement for a primary volume provided to the second processing module by the storage service, determine, on the basis of the volume requirement and storage information, volume configuration information showing the configuration of the primary volume being provisioned from a logical storage area, and determine, on the basis of the volume configuration information, the reliability requirements, and the storage information, replication configuration information showing the configuration of a replication that uses the primary volume as a copy source.

### TECHNICAL FIELD

The present invention relates to a computer system.

### BACKGROUND ART

In storage management, provisioning is a process for selectively using replication functions for retention periods and a recovery point objective (RPO) to determine a storage configuration in terms of reliability. Advances in replication functions, such as snapshotting and cloning, and the diversification of storage configurations in recent years has led to demand for higher degrees of freedom in storage configurations and the determination of configurations suited to usage applications.

PTL 1 discloses a feature for automatically optimizing provisioning performance. This feature determines the storage performance characteristics (capabilities) for workload parameters (e.g., the maximum throughput of a storage, the maximum random reads per second), and executes storage provisioning that satisfies the specified requirements.

### CITATION LIST

### Patent Literature

[PTL 1]

Japanese Translation of PCT Application No. 2008-527555

### SUMMARY OF INVENTION

### Technical Problem

When provisioning is performed on the basis of performance requirements, the requirements do not take reliability into consideration, and therefore provisioning may not be performed in a manner that is preferable to the administrator in a case where a backup or disaster recovery is the objective. Furthermore, in order for an administrator to specify performance characteristics, the administrator must be very familiar with the storage configuration. Therefore, it is difficult to specify appropriate requirements when making use of storage provisioning as a service.

### Solution to Problem

To solve for the above-mentioned problem, a computer system, which is an aspect of the present invention, comprises: a storage device; a first processing module that is coupled to the storage device, and that is configured to process I/O to/from the storage device; a second processing module that is configured to issue a request for the I/O to the first processing module; and a third processing module that is coupled to the first processing module. The first processing module is configured to use a storage area inside the storage device to create a logical storage area, the third processing module is configured to store storage information showing the configuration of the logical storage area, acquire a provisioning request that includes a reliability requirement for reliability of a storage service provided from the first processing module to the second processing module, and a volume requirement for a primary volume provided to the second processing module using the storage service, determine, on the basis of the volume requirement and the storage information, volume configuration information showing the configuration of the primary volume being provisioned from the logical storage area, determine, on the basis of the volume configuration information, the reliability requirement, and the storage information, replication configuration information showing the configuration of a replication that uses the primary volume as a copy source, and send the volume configuration information and the replication configuration information to the first processing module, and the first processing module is configured to provision the primary volume from the logical storage area on the basis of the volume configuration information, and to execute the replication on the basis of the replication configuration information.

### Advantageous Effects of Invention

The present invention makes it possible to execute volume provisioning that satisfies a reliability requirement without the administrator being aware of the storage configuration.

### BRIEF DESCRIPTION OF DRAWINGS

FIG. 1 shows the configuration of a computer system.

FIG. 2 shows the configuration of a management system 200.

FIG. 3 shows pool configuration information 810.

FIG. 4 shows pool load information 820.

FIG. 5 shows storage profile information 830.

FIG. 6 shows service profile information 840.

FIG. 7 shows replication cost information 850.

FIG. 8 shows replication management information 860.

FIG. 9 shows a provisioning process.

FIG. 10 shows a P-VOL pool selection process.

FIG. 11 shows a cost calculation process.

FIG. 12 shows an S-VOL pool selection process.

FIG. 13 shows a profile generation process.

FIG. 14 shows a storage profile input screen.

FIG. 15 shows a service profile input screen.

FIG. 16 shows a provisioning request screen.

### DESCRIPTION OF EMBODIMENTS

In the following explanation, information in the examples is explained using the expression “table”, but the information may not be always expressed using this data structure. For example, the information may be expressed using a data structure such as a “list”, “database (DB)”, “queue” or some other structure. Thus, to show that the information is not dependent on the data structure, a “file”, “index”, “table”, “list”, “DB”, and “queue”, etc., may also simply be called “information”. Furthermore, when explaining the content of the respective information, the expressions “identification information”, “identifier”, “name”, “ID”, and “number” may be used, but these expressions are interchangeable.

In the following explanation, there may be cases where an explanation has “program” as the subject, but since the stipulated processing is performed in accordance with a program being executed by a central processing unit (CPU) while using a memory and a communication port (a communication control apparatus), the CPU may be used as the subject of the explanation. A process, which is described using program as the subject, may be regarded as a process performed by a computer, such as a server, a storage controller, a management computer, or an information processing apparatus. Either all or a portion of a program may be realized by dedicated hardware, or may be modularized. Various programs may be installed in respective computers using a program delivery server or computer readable storage media.

A management computer has an input/output device. The input/output device, for example, may be a display, a keyboard, or a pointing device, or may be another such device. A serial interface or an Ethernet interface may be used as an input/output device in place of the input/output device, a computer for display use having a display, a keyboard, or a pointer device may be coupled to the relevant interface, and by sending display information to the display computer and/or receiving input information from the display computer, the relevant interface may substitute for the input and displays on an input/output device by carrying out displays on and receiving information from the display computer.

Hereinafter, a cluster of one or more computers that manages a computer system and displays the display information of the present invention may be called a management system. When a management computer displays the display information, the management computer is the management system. Furthermore, a combination of a management computer (management server) and a display computer (administrator computer) is also a management system. Furthermore, the same processing as that of the management computer may be realized using a plurality of computers to increase the speed and enhance the reliability of management processes, and in this case, the relevant plurality of computers (may include a display computer in a case where a display computer performs displays) constitute the management system.

In the present embodiment, provisioning is assigned to a prescribed entity (e.g., a host computer, or a host computer administrator) along with either an existing volume or the creation of a new volume. Furthermore, when the entity is a host computer, the provisioning may include operations that open a path and/or operations that change an access control list (ACL).

A service is an automated workflow, and in the present embodiment, is a workflow for automating storage provisioning. Each service can maintain various parameters (e.g., volume size, number of volumes) necessary for executing the workflow, and can configure the values of the parameters for each application (e.g., database, virtual server data store). When a requirement for a service that is not dependent on the physical configuration of the storage is configured as a parameter, a storage configuration for the requirement is determined at the time of workflow execution. Furthermore, a service that provides a volume from a storage apparatus to a host computer is called a storage service.

The configuration of the computer system in the examples of the present invention will be explained below.

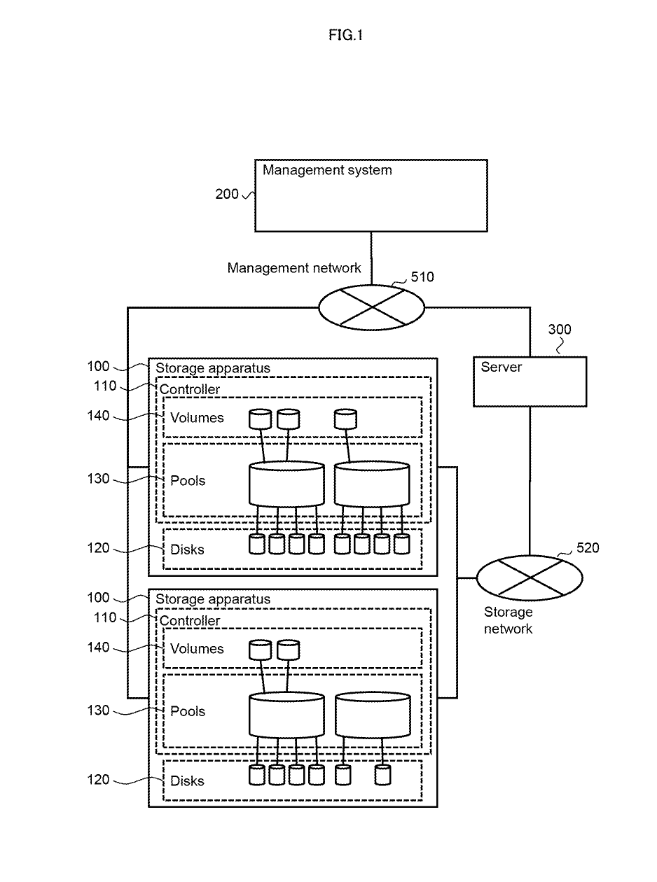

FIG. 1 shows the configuration of the computer system.

The computer system includes a plurality of storage apparatuses 100, a management system 200, and a server 300. The management system 200 is coupled to the plurality of storage apparatuses 100 and to the server 300 through a management network 510. The management network 510, for example, is a local area network (LAN). The server 300 is coupled to the plurality of storage apparatuses 100 through a storage network 520. The storage network 520, for example, is a storage area network (SAN). Furthermore, the server 300 may be called a host computer.

The storage apparatus 100 includes a controller 110, and a plurality of disks 120. A disk 120 is a storage device such as a hard disk drive (HDD), or a solid state drive (SSD). The controller 110, in response to an indication from the management system 200, is configured to create a pool 130 that includes storage areas inside the plurality of disks 120, to create a volume 140 associated with the pool 130, and to provide the volume 140 to the server 300. The controller 110 is configured to allocate a storage area inside the pool 130 to the volume 140 in response to a write to the volume 140. Hereafter, a data center or the like at which the storage apparatus 100 is installed is called a site.

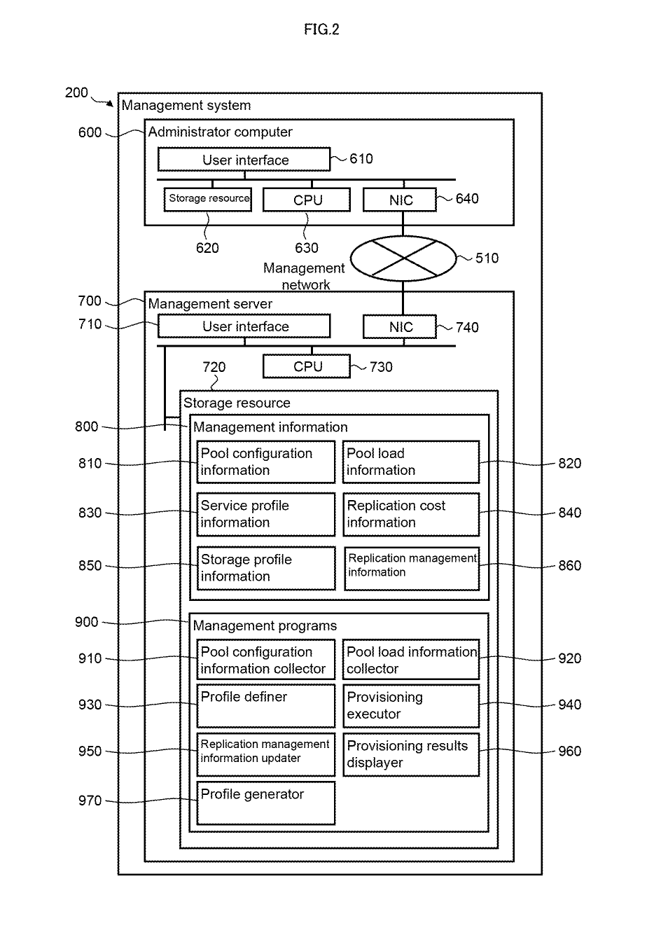

FIG. 2 shows the configuration of the management system 200.

The management system 200 includes an administrator computer 600 and a management server 700.

The administrator computer 600 includes a user interface 610, a storage resource 620, a central processing unit (CPU) 630, and a network interface card (NIC) 640. The user interface 610 is configured to display information indicated from the CPU 630, and to acquire information inputted by the administrator. The storage resource 620 is configured to store data and programs, such as a browser. The CPU 630 is configured to execute processing on the basis of programs stored in the storage resource 620. The NIC 640 is coupled to the management server 700 through the management network 510.

The CPU 630 is configured to receive information from the management server 700 via the NIC 640, to display the received information on the user interface 610, and to send the information acquired by the user interface 610 to the management server 700 via the NIC 640.

The management server 700 includes a user interface 710, a storage resource 720, a CPU 730, and a NIC 740. The user interface 710 is configured to display information indicated from the CPU 730, and to acquire information inputted by the administrator. The storage resource 720 is configured to store data and programs. The CPU 730 is configured to execute processing on the basis of the programs stored in the storage resource 720. The NIC 740 is coupled to the administrator computer 600 through the management network 510.

The CPU 730 is configured to receive information from either the storage apparatus 100 or the administrator computer 600 via the NIC 740, to perform processing, and to send the results of the processing to either the storage apparatus 100 or the administrator computer 600 via the NIC 740. Furthermore, the CPU 730 may be configured to receive the information inputted by the administrator using the user interface 710.

The storage resource 720 is configured to store management programs 900 and management information 800.

The management programs 900 include a pool configuration information collector 910, a pool load information collector 920, a profile definer 930, a provisioning executor 940, a replication management information updater 950, a provisioning results displayer 960, and a profile generator 970. Each of the programs will be described below.

The management information 800 includes pool configuration information 810, pool load information 820, storage profile information 830, service profile information 840, replication cost information 850, and replication management information 860.

The pool configuration information collector 910 is configured to collect information related to the configuration of the pool from the storage apparatus 100, and to create the pool configuration information 810 on the basis of the collected information. The pool load information collector 920 is configured to collect information related to the pool load from the storage apparatus 100, and to create the pool load information 820 on the basis of the collected information. The profile definer 930 is configured to create the storage profile information 830 and the service profile information 840 on the basis of inputs to either the administrator computer 600 or the management server 700 by the administrator.

The provisioning executor 940 is configured to acquire a provisioning request from the administrator computer 600, and to execute a provisioning process for creating a volume 140, such as a primary volume (P-VOL) and a secondary volume (S-VOL), from the pool 130 on the basis of the provisioning request. The provisioning executor 940 is configured to construct the pool 130 by integrating one or more disks 120. The provisioning executor 940 is configured to distinguish between the allocation of the volume 140 to an application and the allocation of an area inside the disk 120, and to allocate an area inside the disk 120 when needed in accordance with application area usage. When a provisioning request does not request replication, the provisioning executor 940 is configured to create a P-VOL, and when a provisioning request requests replication, the provisioning executor 940 is configured to create a P-VOL and an S-VOL.

In the present example, the provisioning executor 940 is configured to create a pool from a plurality of disks 120, and on the basis of a provisioning request, to create the volume 140 (virtual volume) from the pool using thin provisioning. The storage apparatus 100 is configured to allocate a storage area inside the pool to the volume 140 in response to a write request from the server 300. Furthermore, the provisioning executor 940 may be configured to create a parity group from the plurality of disks 120, and on the basis of a provisioning request, may be configured to extract the volume 140 (logical volume) from the parity group. The storage apparatus 100 is configured to write to the parity group corresponding to the volume 140 in response to a write request from the server 300. In other words, the provisioning executor 940 is configured to indicate to the storage apparatus 100 to create a logical storage area using a storage area inside the disk 120, and the provisioning executor 940 is configured to indicate to the storage apparatus 100 to provision the P-VOL from the logical storage area. The storage apparatus 100 is configured to create a logical storage area using a storage area inside the disk 120 in response to an indication from the management server 700, and to provision the P-VOL from the logical storage area in response to an indication from the management server 700.

The replication management information updater 950 is configured to create the replication management information 860 with respect to a replication configuration between the P-VOL and the S-VOL. Replication is a process for sharing data between redundant storage resources while maintaining integrity to enhance data reliability. In the present example, the redundant storage resources are the P-VOL and the S-VOL. Replication includes copy types, such as shadow image (SI) and thin image (TI). SI is an example of cloning, and cloned data of the P-VOL is written to a storage area allocated to the S-VOL inside the same storage apparatus 100. TI is an example of a snapshot, and only differences between the P-VOL and snapshot data are written to a storage area allocated to the S-VOL inside the same storage apparatus 100. The difference data may be data prior to updating by a P-VOL update, or may be data subsequent to updating by a P-VOL update. The storage area allocated to the S-VOL for the snapshot may be allocated from a snapshot pool, or may be allocated from a normal pool. The replication may be a local copy in which copying is performed within the same storage apparatus 100 like SI and TI, or may be a remote copy in which copying is performed between two storage apparatuses 100.

The provisioning results displayer 960 is configured to display the results of provisioning on the administrator computer 600. Provisioning results show a P-VOL pool (first pool), which is a pool furnished to the P-VOL, an S-VOL pool, which is a pool furnished to the S-VOL, the P-VOL, the S-VOL, and so forth. The profile generator 970 is configured to perform a profile generation process for generating the storage profile information 830. Furthermore, the management programs 900 need not include the profile generator 970.

The management information 800 will be explained below.

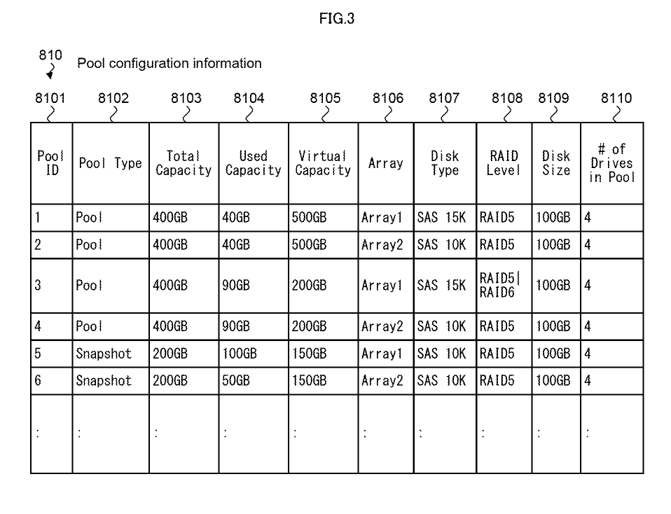

FIG. 3 shows the pool configuration information 810.

The pool configuration information 810 has an entry for each pool. A single pool entry includes a pool ID 8101, a pool type 8102, a total capacity 8103, a used capacity 8104, a virtual capacity 8105, an array 8106, a disk type 8107, a RAID level 8108, a disk size 8109, and a number of drives in pool (If of drives in pool) 8110.

The pool ID 8101 is the pool identifier. The pool type 8102 shows the type of the pool. The pool type 8102, for example, shows a normal pool for the P-VOL and the S-VOL, and a snapshot pool for storing snapshot difference data. The total capacity 8103 is the total capacity of the disks registered in the pool. The used capacity 8104 is the total capacity of the storage area allocated to a volume from the pool. The virtual capacity 8105 is the total volume size of the volume(s) furnished from the pool. The array 8106 is the identifier of the storage apparatus 100 that includes the pool. The disk type 8107 shows the type and rotational speed of the disks included in the pool. This type, for example, shows a serial attached SCSI (small computer system interface) (SAS), a serial ATA (advanced technology attachment) (SATA), a solid state drive (SSD), etc. The RAID level 8108 is the RAID level of a RAID group included in the pool. The disk size 8109 is the size of the disks included in the pool. The number of drives in pool 8110 is the number of disks included in the pool. Furthermore, any of the disk type 8107, RAID level 8108, and disk size 8109 included in the pool may indicate a plurality of values. The entry may include information showing a site where the storage apparatus 100 is installed. The management information 800 may include information showing site location information, distance between sites, inter-site bandwidth, etc.

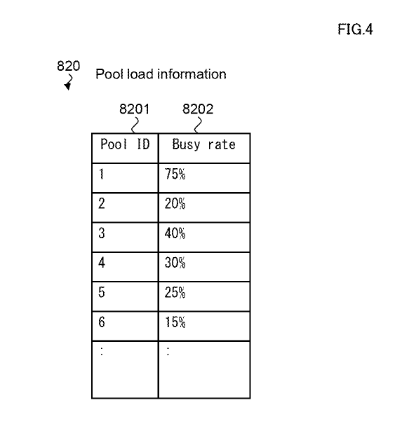

FIG. 4 shows the pool load information 820.

The pool load information 820 has an entry for each pool. A single pool entry includes a pool ID 8201, and a busy rate 8202.

The pool ID 8201 is the pool identifier. The busy rate 8202 is the busy rate [%] of the pool. Input/output per second (IOPS), response time, queue length, etc., may be used in place of the busy rate as a pool performance index.

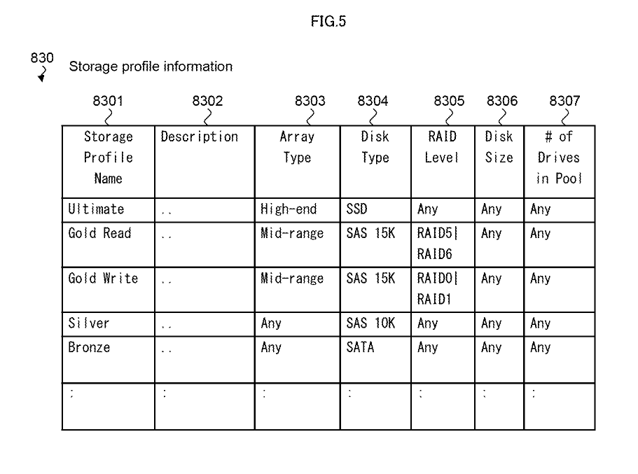

FIG. 5 shows the storage profile information 830.

The storage profile information 830 has an entry for each storage profile. The storage profile is information defining the physical characteristics for classifying a storage in terms of performance, and shows performance requirements for the performance of a storage service. When a volume is allocated from a pool, the storage profile shows the physical characteristics of the disks comprising the pool. A single storage profile entry includes a storage profile name 8301, a description 8302, an array type 8303, a disk type 8304, a RAID level 8305, a disk size 8306, and a number of drives in pool 8307.

The storage profile name 8301 is the name of the storage profile. The description 8302 is an explanation of the storage profile for the administrator. The array type 8303 shows the type and format of the storage apparatus 100. The array type 8303, for example, shows, High-end, mid-range, etc. The disk type 8304 shows the type and rotational speed of the disks. The disk type 8304 can be converted to seek time, data transfer wait time, data transfer rate, etc. The RAID level 8305 shows the RAID level. The disk size 8306 shows the type and rotational speed of the disks. The number of drives in pool 8307 is the number of disks included in the pool. Furthermore, both the array type 8303 and the RAID level 8305 may show a plurality of values. The disk size 8306 and the number of drive in pool 8307 may show a range of values.

One or more physical characteristics can be defined. For example, a storage profile, which is for a service for provisioning a high-performance storage, is defined on the basis of the requirements for the storage used by the service, such as specifying high-end in the array type 8303, and specifying SSD in the disk type 8304. The definition and specification methods of a storage profile, for example, may be generated by the profile generator 970 based on application requirements using a profile generating process described hereinbelow.

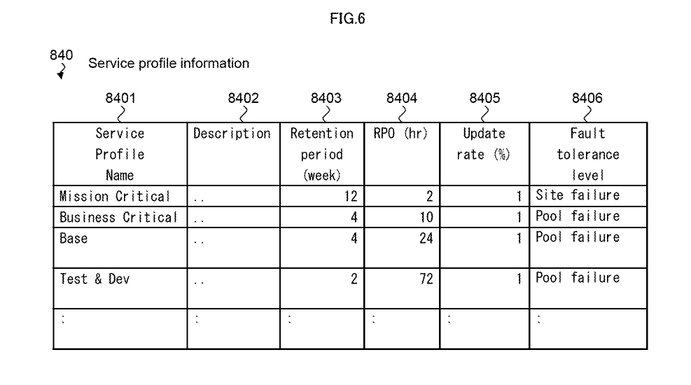

FIG. 6 shows the service profile information 840.

The service profile information 840 has an entry for each service profile. The service profile is information defining common requirements for storage services, and shows reliability requirements for the reliability of the storage service. A single service profile entry includes a service profile name 8401, a description 8402, a retention period 8403, a RPO 8404, an update rate 8405, and a fault tolerance level 8406.

The service profile name 8401 is the name of the service profile. The description 8402 is an explanation of the service profile for the administrator. The retention period 8403 shows the data retention period [week]. The RPO 8404 is the recovery time objective (RPO) [hour]. The update rate 8405 is the percentage of the data size to be updated per unit of time with respect to the volume capacity. The unit of time, for example, is one week. An update quantity, such as the data size, that is updated per unit of time may be used in place of the update rate.

The fault tolerance level 8406 is a requirement to which a level has been assigned in accordance with the extent of the impact when a failure occurs, and shows the level of fault tolerance required in a volume. The fault tolerance level 8406, for example, shows an application failure, a pool failure, an apparatus failure, a site failure, etc.

Application failure requires that it be possible to deal with a failure in an application (host computer) that is using a volume. In this case, the requirement is that the storage apparatus 100 be capable of dealing with the redundant configuration (e.g., multi-path configuration) of the application. The replication configuration in this case may be either local copy or remote copy.

Pool failure requires that it be possible to deal with a failure in the P-VOL pool. In this case, the requirement is that the S-VOL pool be different from the P-VOL pool. When the replication configuration is local copy, the provisioning executor 940 is configured to select, as the S-VOL pool, a different pool in the storage apparatus 100 that includes the P-VOL pool. When the replication configuration is remote copy, the requirement is met. However, the provisioning executor 940, on the basis of the relationship between the storage apparatus 100 that includes the P-VOL and the storage apparatus 100 that includes the S-VOL (the physical distance, data communication rate, and so forth between the storage apparatuses), is configured to select the location of the storage apparatus 100 that includes the S-VOL, and either the remote copy synchronous mode or asynchronous mode.

Apparatus failure requires that it be possible to deal with a failure in the storage apparatus 100 that includes the P-VOL. In this case, since the storage apparatus 100 that includes the S-VOL must be different from the storage apparatus 100 that includes the P-VOL, the requirement is that the replication configuration be the remote copy. In this case, the same as for a pool failure, the provisioning executor 940, on the basis of the relationship between the storage apparatus 100 that includes the P-VOL and the storage apparatus 100 that includes the S-VOL, is configured to select the location of the storage apparatus 100 that includes the S-VOL, and either the remote copy synchronous mode or asynchronous mode.

Site failure requires that it be possible to deal with a failure at the site (data center) that includes the P-VOL. In this case, since the site that includes the S-VOL must be different from the site that includes the P-VOL, the requirements are that the replication configuration be the remote copy, and that the site that includes the S-VOL must be different from the site that includes the P-VOL. In this case, the provisioning executor 940, on the basis of the relationship between the storage apparatus 100 that includes the P-VOL and the storage apparatus 100 that includes the S-VOL, is configured to select the location of the storage apparatus 100 including the S-VOL within the site that satisfies the requirement, and either the remoter copy synchronous mode or asynchronous mode.

The fault tolerance level 8406 may be defined in even more detail in accordance with the requirement. The fault tolerance level 8406 may be expressed using the array 8106, the disk type 8107, the RAID level 8108, etc., or may be expressed using the site information.

The service profile may include requirements, such as performance other than reliability (e.g., performance that can be expressed by any of high, medium, or low), availability (e.g., shows that the rate of operation is 99.999%) and security. Furthermore, a storage profile may be specified as one item of the service profile. For example, when the service profile includes a recovery time objective (RTO), which is the time required to recover from the failure and resume operation, the provisioning executor 940, in order to satisfy the RTO, is configured to determine the volume configuration by taking into account the transfer rate of the storage network 520, the write performance of the storage apparatus 100, and so forth.

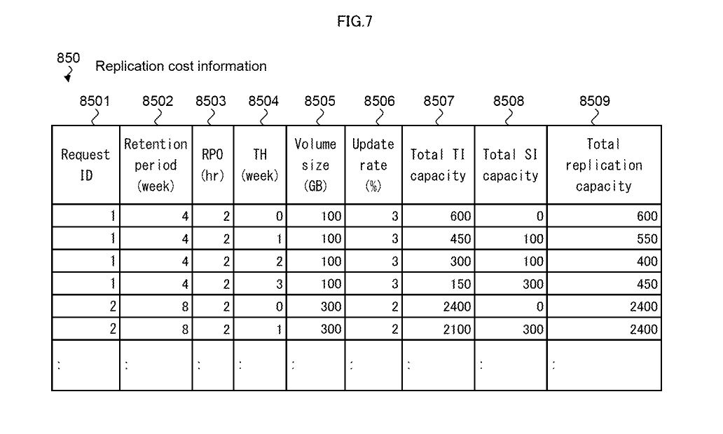

FIG. 7 is the replication cost information 850.

The replication cost information 850 has an entry for each replication candidate. A single replication candidate entry includes a request ID 8501, a retention period 8502, a RPO 8503, a SI retention period (TH) 8504, a volume size 8505, an update rate 8506, a total TI capacity 8507, a total SI capacity 8508, and a total replication capacity 8509.

The request ID 8501 is the identifier of the provisioning request that constitutes the basis of the replication candidate. The retention period 8502 is the retention period for the replication candidate. The RPO 8503 is the time traced backward using the S-VOL in a case where an accident or incident, such as an information system stoppage, has occurred, and as used here is the RPO for the replication candidate. The SI retention period 8504 is the retention period for the SI of the replication candidate. The volume size 8505 is the volume size specified by the volume requirement in the provisioning request. The update rate 8506 is the update rate for the replication candidate. The total TI capacity 8507 is the capacity needed for the replication candidate TI. The total SI capacity 8508 is the capacity needed for the replication candidate SI. The total replication capacity 8509 is the sum of the total TI capacity 8507 and the total SI capacity 8508 of the replication candidate.

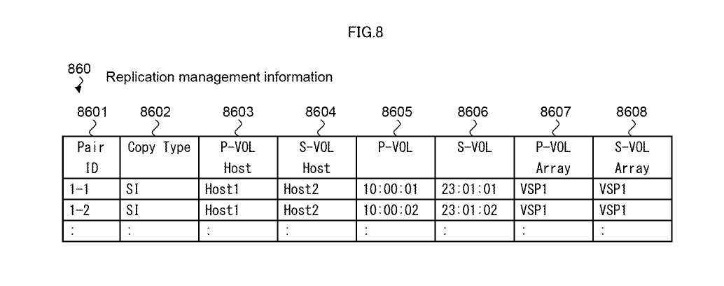

FIG. 8 shows the replication management information 860.

The replication management information 860 has an entry for each replication pair. A single pair entry includes a pair ID 8601, a copy type 8602, a P-VOL host 8603, an S-VOL host 8604, a P-VOL 8605, an S-VOL 8606, a P-VOL array 8607, and an S-VOL array 8608.

The pair ID 8601 is the pair identifier. The copy type 8602 shows the copy type of the pair. The copy type 8602, for example, shows SI, TI, etc. The P-VOL host 8603 is the identifier of the P-VOL host, which is the server 300 that uses the P-VOL of the pair. The S-VOL host 8604 is the identifier of the S-VOL host, which is the server 300 that uses the S-VOL of the pair. The P-VOL 8605 is the P-VOL identifier. The S-VOL 8606 is the S-VOL identifier. The P-VOL array 8607 is the identifier of the storage apparatus 100 that includes the P-VOL. The S-VOL array 8608 is the identifier of the storage apparatus 100 that includes the S-VOL.

The operation of the management server 700 will be explained below.

The provisioning executor 940, upon receiving a provisioning request from the administrator computer 600, is configured to commence a provisioning process for creating a volume on the basis of the provisioning request.

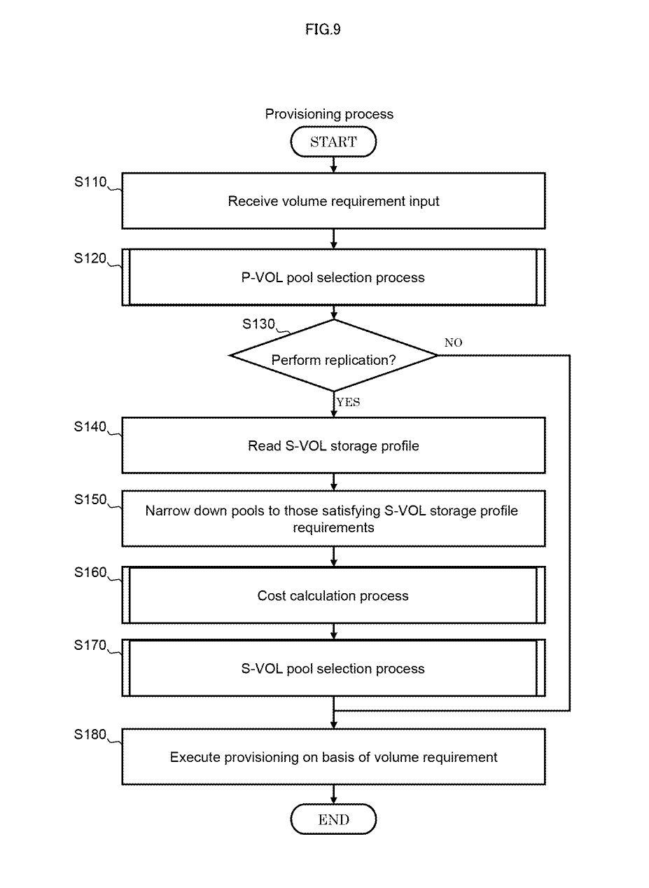

FIG. 9 shows the provisioning process.

First, in S110, the provisioning executor 940 is configured to receive a provisioning request from the administrator computer 600. The provisioning request includes a volume requirement. The volume requirement is the requirement for the P-VOL, which constitutes the target of the provisioning, and includes the volume size and number of volumes of the P-VOL. When the number of volumes is configured beforehand, the volume requirement need not include the number of volumes. The provisioning request may additionally include a P-VOL storage profile name, which is the name of the storage profile for the P-VOL. The provisioning request may additionally show whether or not a P-VOL replication is to be performed. When the replication is to be performed, the provisioning request may additionally include a service profile name, and an S-VOL storage profile name, which is the name of the storage profile for the S-VOL.

Thereafter, in S120, the provisioning executor 940 is configured to execute a P-VOL pool selection process for selecting a P-VOL pool.

Thereafter, in S130, the provisioning executor 940 is configured to determine whether or not the provisioning request shows a replication. When it has been determined in S130 that the provisioning request does not show a replication (No), the provisioning executor 940 is configured to move the processing to S180.

When it has been determined in S130 that the provisioning request shows a replication (Yes), in S140, the provisioning executor 940 is configured to acquire the S-VOL storage profile name specified by the provisioning request, and to read the storage profile corresponding to the S-VOL storage profile name from the storage profile information 830.

Thereafter, in S150, the provisioning executor 940 is configured to select, from the pool configuration information 810, a pool, which satisfies the physical characteristic requirements shown in the read storage profile, as a first S-VOL pool candidate.

Thereafter, in S160, the provisioning executor 940 is configured to execute a cost calculation process for calculating the replication configuration candidate, which is the candidate for the replication configuration, and the cost thereof.

Thereafter, in S170, the provisioning executor 940 is configured to execute an S-VOL pool selection process for selecting a replication configuration from among the replication configuration candidates, and an S-VOL pool.

Thereafter, in S180, the provisioning executor 940, using the selected replication configuration, the selected P-VOL pool, and the selected S-VOL pool, is configured to determine the P-VOL ID and the S-VOL ID from the results of provisioning from the storage apparatus 100 and to return the P-VOL ID and the S-VOL ID to the administrator computer 600 by sending a provisioning indication based on the volume requirements to the storage apparatus 100 corresponding to the P-VOL pool and the S-VOL pool, and to end the flow. At this point, the provisioning executor 940 is configured to execute provisioning to the storage apparatus 100 by sending to the storage apparatus 100 the volume configuration information showing the P-VOL configuration, and the replication configuration information showing the S-VOL configuration. The volume configuration information shows the creation of the P-VOL using the P-VOL pool. The replication information shows the creation of the S-VOL using the S-VOL pool, and the replication configuration between the P-VOL and the S-VOL.

According to the above provisioning process, the provisioning executor 940 is configured to be able to determine the P-VOL pool, the S-VOL pool, and the replication configuration that satisfy the provisioning request.

The provisioning executor 940 is configured to execute the P-VOL pool selection process in S120 described above.

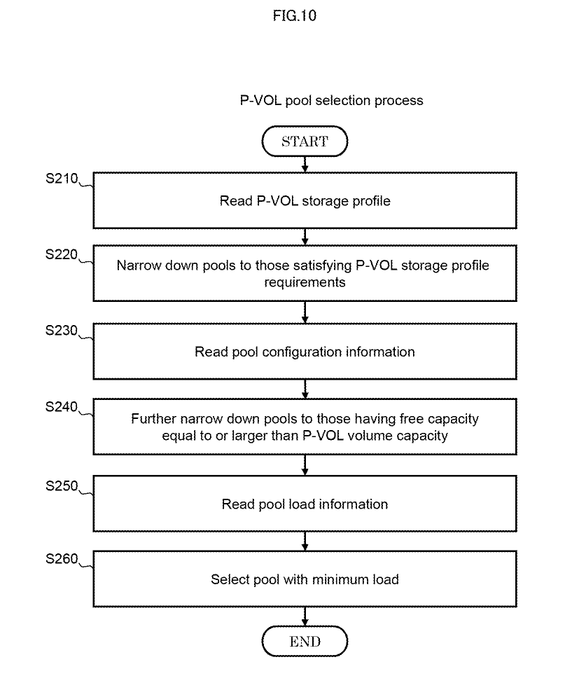

FIG. 10 shows the P-VOL pool selection process.

First, in S210, the provisioning executor 940 is configured to acquire the P-VOL storage profile name specified by the provisioning request, and to read the storage profile corresponding to the P-VOL storage profile name from the storage profile information 830.

Thereafter, in S220, the provisioning executor 940 is configured to select, as first P-VOL pool candidates, pools from the pool configuration information 810 that satisfy the physical characteristics requirements shown in the read storage profile.

Thereafter, in S230, the provisioning executor 940 is configured to read the pool configuration information 810.

Thereafter, in S240, the provisioning executor 940 is configured to use the pool configuration information 810 to select, as second P-VOL pool candidates, pools from among the first P-VOL pool candidates that have free capacity of equal to or larger than the P-VOL volume size shown in the volume requirements (size of an unused area).

Thereafter, in S250, the provisioning executor 940 is configured to read the pool load information 820.

Thereafter, in S260, the provisioning executor 940 is configured to use the pool load information 820 to select, as the P-VOL pool, the pool that has the smallest load among the second P-VOL pool candidates, and to end the flow. The load, for example, is the busy rate.

According to the P-VOL pool selection process described above, the provisioning executor 940 is configured to be able to select a pool that satisfies the capacity and performance shown in the provisioning request with respect to the P-VOL. The P-VOL pool selection process is configured to be able to level the loads of a plurality of pools. The provisioning executor 940, in order to show the configuration of the P-VOL, is configured to determine volume configuration information including at least any of the volume size, the number of volumes, and the P-VOL pool, thereby making it possible to indicate to the storage apparatus 100 to provision the P-VOL on the basis of the volume configuration information.

In S260, the provisioning executor 940 may be configured so as to bias the loads for a plurality of pools by selecting a pool with a relatively large load as the P-VOL pool. Furthermore, an S260 operation like this may be configured in accordance with a policy, or the like. Furthermore, another performance index may be used in place of the load.

The provisioning executor 940 is configured to execute the cost calculation process in S160 described above.

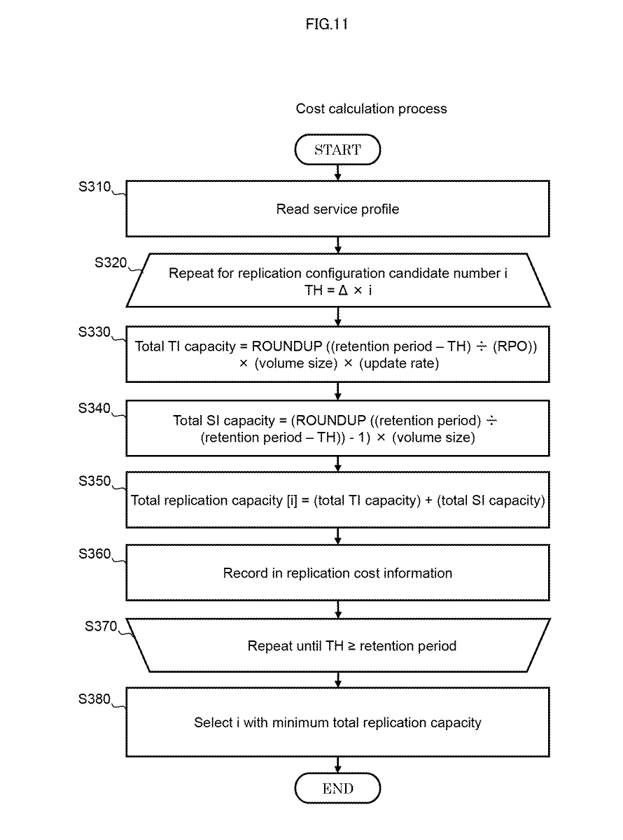

FIG. 11 shows the cost calculation process.

First, in S310, the provisioning executor 940 is configured to acquire the service profile name specified by the provisioning request, and to read the service profile corresponding to the service profile name from the service profile information 840. The service profile includes a replication requirement.

Thereafter, in S320, the provisioning executor 940 is configured to initialize a replication configuration candidate number i to 0, to calculate Δ×i as TH(i) using a preconfigured divided time interval Δ, and to determine the TI and SI configurations defined by TH(i) as replication configuration candidates. The Δ, for example, is one week. TH(i) is the retention period for the S-VOL created using SI, and is called the SI retention period.

Thereafter, in S330, the provisioning executor 940 is configured to use the retention period specified by the service profile to calculate, using the following formula, the total TI capacity (i), which is an estimate of the total size of the difference data of all snapshot generations created using TI.

Total TI capacity (i)=ROUNDUP ((retention period−TH(i))÷RPO)×volume size×update rate

As used here, (retention period−TH(i)) is the retention period for the S-VOL created using TI, and is called the TI retention period. RPO is the interval between TIs, and is called the TI interval. ROUNDUP (TI retention period TI interval) is the number of generations of TI, and is called the number of TI generations. ROUNDUP (x) shows the roundup function. The volume size×update rate is the size of the difference data using one generation of TI, and is the size of the S-VOL for the TI, and is called the TI volume size.

Thereafter, in S340, the provisioning executor 940 is configured to calculate, using the following formula, the total SI capacity, which is an estimate of the total size of all generations of S-VOLs (P-VOL cloned volumes) created using SI.

Total SI capacity (i)=ROUNDUP (retention period÷(retention period−TH(i))−1)×volume size

As used here, (retention period−TH(i)) is the TI retention period in conjunction with the interval between SIs, and is called the SI interval. ROUNDUP (retention period=SI interval−1) is the number of generations of SIs, and is called the number of SI generations. The size of the S-VOL for SI is equivalent to the volume size of the P-VOL, and is called the SI volume size.

Thereafter, in S350, the provisioning executor 940 is configured to calculate, as the cost, the total replication capacity (i), which is the total of the total TI capacity (i) and the total SI capacity (i). In this example, the cost is the capacity.

Thereafter, in S360, the provisioning executor 940 is configured to create an entry for a replication configuration candidate in the replication cost information 850. The entry includes the read service profile information, the TH(i), the total TI capacity (i), the total SI capacity (i), and the total replication capacity (i).

Thereafter, in S370, the provisioning executor 940 is configured to determine whether or not the TH(i) is equal to or larger than the retention period, and when the TH(i) is not equal to or larger than the retention period, to move the processing to S320, to add 1 to i, and to repeat S320 to S370.

Thereafter, in S380, the provisioning executor 940 is configured to select as i_min the i for which the cost is the lowest from among the entries corresponding to the target provisioning request in the replication cost information 850, and to end this flow. In this example, the cost is the total replication capacity (i).

According to the cost calculation process described above, the provisioning executor 940 is configured to be able to create a replication configuration candidate using only TI, or a replication configuration candidate using both TI and SI. It is possible to determine the replication configuration having the minimum cost.

The provisioning executor 940, in order to show the TI configuration determined by the cost calculation process, is configured to be able to indicate a TI to the storage apparatus 100 on the basis of the TI configuration information by determining the TI configuration information (snapshot configuration information) that includes at least any of the TI volume size, the number of TI generations, the TI retention period, and the total TI capacity. The provisioning executor 940, in order to show the SI configuration determined by the cost calculation process, is configured to be able to indicate an SI to the storage apparatus 100 on the basis of the SI configuration information by determining the SI configuration information (cloning configuration information) that includes at least any of the SI volume size, the number of SI generations, the SI retention period, and the total SI capacity. Furthermore, the provisioning executor 940 is configured to be able to determine at least either of the TI configuration information or the SI configuration information by using time information that includes either the retention period or the RPO to show the time used in replication, and the update quantity information that includes any of the update rate, the volume size, or the update quantity to show the P-VOL update quantity. The provisioning executor 940 is configured to be able determine, using the time information and the update quantity information, the number of TI generations and the number of SI generations as conditions for the cost required for the replication configuration being the minimum. This enables the administrator to minimize the cost of the replication configuration without being aware of the storage apparatus 100 configuration.

Furthermore, when the formula for determining either the i_min or the cost has been preconfigured, the provisioning executor 940 may be configured so as to calculate the i_min using the formula. Since there is a trade-off between the replication configuration capacity and the RPO, the provisioning executor 940 may be configured so as to display a plurality of replication configuration candidates on the administrator computer 600, and to determine the replication configuration candidate selected by the administrator as the replication configuration.

When an upper limit for the number of TI generations has been preconfigured for the storage apparatus 100, the provisioning executor 940 may be configured so as to determine the replication configuration having a number of TI generations that is equal to or less than the upper limit as a condition. When the number of TI generations of replication configuration candidates exceeds the upper limit, the provisioning executor 940 may be configured so as to delete the replication configuration candidate. This enables the administrator to narrow down the replication configuration candidates to those suited to the array type without being aware of the upper limit of the number of generations. By making use of both TI and SI, the RPO requirement can be satisfied even when the number of TI generations of the replication configuration candidate exceeds the upper limit.

Furthermore, when replication restrictions, such as a preconfigured upper limit for a storage apparatus 100 of a certain array type, or a copy type supported by a storage apparatus 100 of a certain array type, has been preconfigured for each storage apparatus 100 array type, the provisioning executor 940 may be configured so as to recognize the replication restriction on the basis of the array type 8303 of the storage profile, and to determine the replication configuration candidate in accordance with the restriction. This enables the administrator to narrow down the replication configuration candidates to those suited to the array type without being aware of the restrictions resulting from the array type.

The provisioning executor 940 is configured to execute the S-VOL pool selection process in S170 described above.

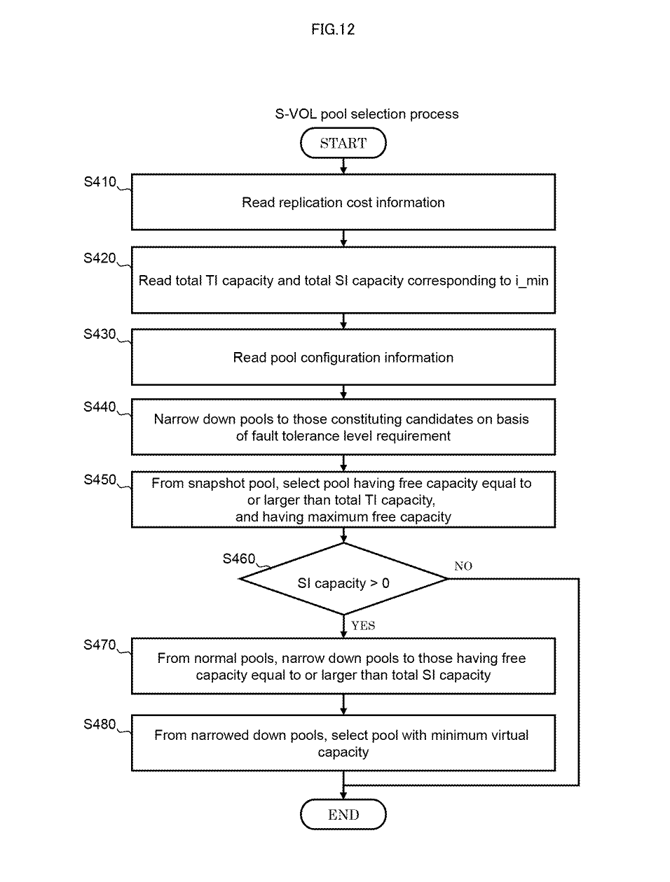

FIG. 12 shows the S-VOL pool selection process.

First, in S410, the provisioning executor 940 is configured to read the replication cost information 850.

Thereafter, in S420, the provisioning executor 940 is configured to read the entry corresponding to i_min from the replication cost information 850.

Thereafter, in S430, the provisioning executor 940 is configured to read the pool configuration information 810.

Thereafter, in S440, the provisioning executor 940 is configured to use the pool configuration information 810 to select, as a second S-VOL pool candidate, a pool from among the first S-VOL pool candidates that satisfies the requirement of the fault tolerance level 8406 in the service profile. According to the fault tolerance level 8406 described above, there may be cases where the second S-VOL pool candidate is a pool in the same storage apparatus 100 as the P-VOL pool, or a pool in a different storage apparatus 100 from that of the P-VOL pool.

Thereafter, in S450, the provisioning executor 940 is configured to select, as a TI pool (second pool), a pool from among the second S-VOL pool candidates that has the pool type 8102 snapshot pool, has free capacity equal to or larger than the total TI capacity (i_min), and has the maximum free capacity. The free capacity is the value obtained by subtracting the used capacity 8104 from the total capacity 8103.

Thereafter, in S460, the provisioning executor 940 is configured to determine whether or not the total SI capacity (i_min) is positive. When it is determined in S460 that the total SI capacity (i_min) is not positive (NO), that is, when SI is not used, the provisioning executor 940 is configured to determine the TI pool as the S-VOL pool, and to end this flow.

When it is determined in S460 that the total SI capacity (i_min) is positive (YES), that is, when SI is used, in S470, the provisioning executor 940 is configured to select, as the SI pool candidate, a pool from among the second S-VOL pool candidates that has the pool type 8102 normal pool, and has free capacity that is larger than the total SI capacity (i_min). This makes it possible to narrow down the pools to those that satisfy the capacity.

Thereafter, in S480, the provisioning executor 940 is configured to select, as an SI pool (third pool), a pool from among the SI pool candidates that has the minimum virtual capacity 8105, to determine the TI pool and the SI pool as the S-VOL pool, and to end this flow.

Thereafter, the storage apparatus 100, in accordance with S180 described above, creates a TI S-VOL (snapshot volume) from the TI pool, and creates an SI S-VOL (cloned volume) from the SI pool.

In this example, the virtual capacity 8105 of one pool is the total volume size of the volumes associated with the pool. The volumes associated with the pool include the P-VOL, all generations of TI S-VOLs, and all generations of SI S-VOLs provisioned in accordance with other provisioning requests. This enables the provisioning executor 940 to select an S-VOL pool by taking into account the volume size of all the volumes scheduled to be created in the pool.

Furthermore, the provisioning executor 940 may be configured so as to indicate to the storage apparatus 100 the creation of all generations of S-VOLs at the time of the provisioning process. In a case like this, the provisioning executor 940 may be configured so as to add the sizes of all the created S-VOLs to the virtual capacity 8105. This makes it possible to select the S-VOL pool by taking into account the volume sizes of all volumes scheduled to be created in the future.

Furthermore, at the timing of each generation of snapshots and cloning, the provisioning executor 940 may be configured so as to indicate to the storage apparatus 100 the creation of an S-VOL for the generation thereof. In a case like this, the provisioning executor 940 may be configured so as to add the S-VOL size of the generation thereof to the virtual capacity 8105. This enables the provisioning executor 940 to select the S-VOL pool taking into account the volume sizes of all the volumes created in the current pool.

When the TI pool is selected from normal pool in S450, the provisioning executor 940 may be configured so as to select the TI pool using the virtual capacity the same as in S470 and S480.

According to the S-VOL selection process described above, the provisioning executor 940 is configured to be able to indicate to the storage apparatus 100 the provisioning of an S-VOL for TI from the TI pool and the provisioning of an S-VOL for SI from the SI pool by using the S-VOL selection process to determine replication configuration information that includes at least any of the TI configuration information, the SI configuration information, the TI pool, and the SI pool.

The provisioning executor 940, in accordance with the replication configuration, is configured to be able to select the TI pool on the basis of the fault tolerance level and the free capacity, and to select the SI pool on the basis of the free capacity and the virtual capacity. When the capacity of each pool is fixed, the selection of the SI pool using the virtual capacity makes it possible to select a pool with a low likelihood of the capacity becoming exhausted in the future. It is also possible to level the free capacity of a plurality of pools. Furthermore, the provisioning executor 940 may be configured so as to bias the free capacity of a plurality of pools by selecting as the SI pool a pool that has free capacity equal to or larger than the total SI capacity, and that has a relatively large free capacity. An operation like this may be configured using a policy, or the like.

In S480, the provisioning executor 940 may be configured so as to select the SI pool using the total capacity. For example, the provisioning executor 940 may be configured so as to select, as the SI pool, the pool from among the third S-VOL pool candidates that has a maximum value obtained by subtracting the virtual capacity from the total capacity.

In a case where the S-VOL is created from either a disk or a parity group for each job without using a pool, the volume of each S-VOL must be estimated beforehand. However, it is difficult to estimate capacity consumption and consumption trends in advance.

However, according to this example, it is possible to create a pool with ample capacity in advance and to allocate a storage area in the pool to the S-VOL as needed. Furthermore, the allocation of a storage area in the pool to the S-VOL enables the pool to be shared by a plurality of jobs. This dynamic provisioning makes it possible to delay the securing of a storage area until it is actually needed, and to reduce the frequency at which disks are allocated for the S-VOL. Dynamic provisioning is effective since capacity consumption trends increase when the S-VOL constitutes a plurality of volumes for one P-VOL over a plurality of numbers of generations. Furthermore, a plurality of S-VOLs respectively corresponding to a plurality of jobs (P-VOLs) may share the pool. This makes the task of provisioning the S-VOL for a plurality of jobs easy.

The S-VOL pool selection process is configured to select the S-VOL pool on the basis of the free capacity of the pool as well as the virtual capacity of the pool. The free capacity of the pool is the capacity available at the current point in time. The virtual capacity of the pool is the total volume size of the volumes being supplied from the pool, and is likely to be consumed in the future. The total SI capacity is calculated by multiplying the number of generations by the volume size, and a pool having free capacity equal to or larger than the total SI capacity is selected as the SI S-VOL pool, thereby guaranteeing there is sufficient physical capacity. In addition, the selection of a pool having the minimum virtual capacity makes it possible to reduce the likelihood of the capacity becoming exhausted in the future.

The cost calculation process is configured to determine either a replication configuration using only TI, or a replication configuration using both TI and SI so as to minimize the storage capacity (cost) while satisfying the requirements of the RPO and the retention period, etc. Since the number of replication configuration candidates that take into account the trade-off between the RPO and the capacity becomes enormous, it is difficult for the administrator to determine a replication configuration by taking into account changing usage. When remote replication configuration candidates are added to the replication configuration candidates in the storage apparatus 100, the number of replication configuration candidates increases further. Furthermore, compared to the sizing of individual volumes, the sharing of the pool by a plurality of jobs further enhances the degrees of freedom of the replication configuration.

The profile generator 970 is configured to execute the profile generation process ahead of the provisioning process. A case in which the application to be executed by the server 300 is a database will be explained.

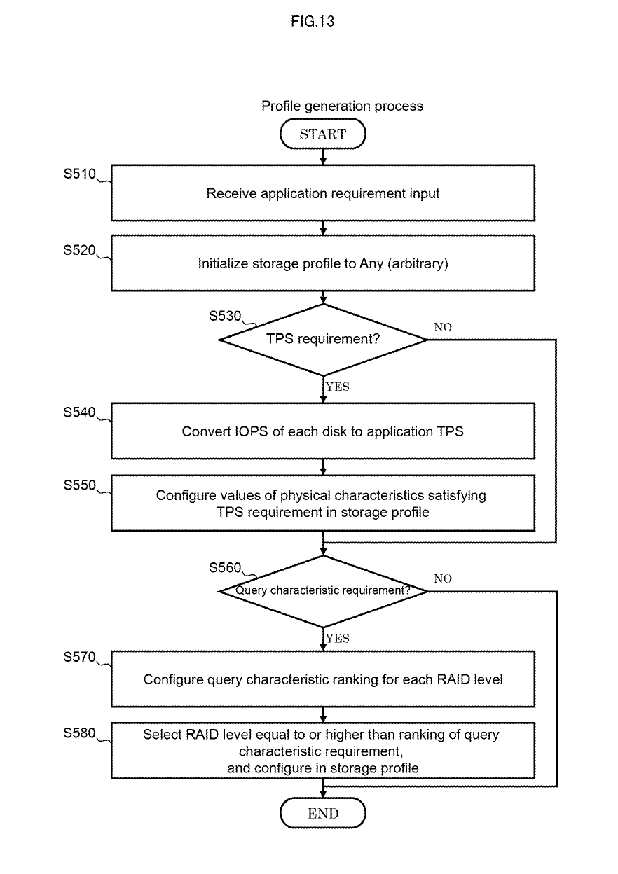

FIG. 13 shows the profile generation process.

First, in S510, the profile generator 970 is configured to receive inputs of a transactions per second (TPS) requirement and a query characteristic requirement as database application requirements from the administrator computer 600. The TPS shows the processing performance. The query characteristic shows the number of reads and the number of writes per unit of time.

Thereafter, in S520, the profile generator 970 is configured to create a new entry in the storage profile information 830, and to configure Any in each field of the new entry. Any shows there are no requirements in the field.

Thereafter, in S530, the profile generator 970 is configured to determine whether or not a TPS requirement has been inputted. When it is determined in S530 that a TPS requirement has not been inputted (NO), the profile generator 970 is configured to move the processing to S560.

When it is determined in S530 that a TPS requirement has been inputted (YES), in S540, the profile generator 970 is configured to acquire a pre-stored IOPS for the pool disks, to calculate the IOPS (throughput) for each pool by multiplying the number of disks in the pool by the IOPS, and to convert the IOPS for each pool to the TPS using a preconfigured formula for the application.

Thereafter, in S550, the profile generator 970 is configured to select from the pool configuration information 810 a pool for which the converted TPS satisfies the TPS requirement, and to configure the value of the physical characteristics of the selected pool (array type, disk type, number of drives in pool) in the new entry. The profile generator 970 may be configured so as to measure the throughput for the application and type of transaction, store the measurement value, and convert the TPS requirement to the physical characteristics of the pool using the measurement value. Furthermore, when there is no measurement value, the profile generator 970 may be configured so as to use the relationship between the preconfigured TPS and the physical characteristics of the pool to convert the TPS requirement to the physical characteristics of the pool.

Thereafter, in S560, the profile generator 970 is configured to determine whether or not a query characteristic requirement has been inputted. When it is determined in S560 that a query characteristic requirement has not been inputted (NO), the profile generator 970 is configured to end this flow.

When it is determined in S560 that a query characteristic requirement has been inputted (YES), in S570, the profile generator 970 is configured to configure a ranking of query characteristics for each RAID level. The ranking shows any of high, mid, and low for each number of reads and each number of writes. For example, when the number of reads is high and the number of writes is low, the profile generator 970 is configured to configure RAID 5 as the RAID level. When the number of reads is high and the number of writes is high, the profile generator 970 is configured to configure RAID 10 as the RAID level. Furthermore, the relationship between the RAID level and the query characteristic may be preconfigured. An access pattern showing either random or sequential may be configured as the query characteristic.

Thereafter, in S580, the profile generator 970 is configured to select a RAID level having a ranking that is equal to or higher than the ranking of the query characteristic requirement, to configure the value of the selected RAID level in the new entry, and to end this flow.

According to the profile generation process described above, the profile generator 970 is configured to be able to generate the storage profile information 830 from the application requirements. The administrator is able to use the appropriate storage profile without being aware of the storage apparatus 100 configuration. Furthermore, the profile definer 930 may be configured so as to create the storage profile information 830 on the basis of inputs from the administrator.

The sequence of the processing in the above management server 700 flow can be changed. For example, in the P-VOL pool selection process, S220, S240, and S260 are interchangeable. Furthermore, for example, in the S-VOL pool selection process, S440 and S450 are interchangeable, and S470 and S480 are interchangeable.

Screens displayed on the administrator computer 600 by the management server 700 will be explained below.

The profile definer 930 is configured to display a storage profile input screen on the administrator computer 600 in response to a request from the administrator computer 600.

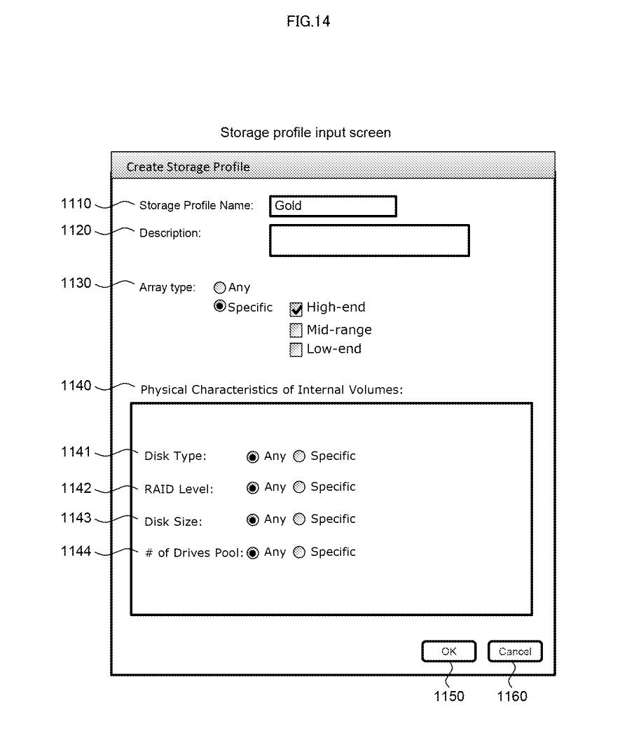

FIG. 14 shows the storage profile input screen.

The storage profile input screen includes a storage profile name field 1110, a description field 1120, an array type field 1130, a physical characteristics field 1140, an OK button 1150, and a cancel button 1160. The physical characteristics field 1140 includes a disk type field 1141, a RAID level field 1142, a disk size field 1143, and a number of drives in pool field 1144.

A value to be configured in the storage profile name 8301 is inputted in the storage profile name field 1110. A value to be configured in the description 8302 is inputted in the description field 1120. A value to be configured in the array type 8303 is inputted in the array type field 1130. Physical characteristics are inputted in the physical characteristics field 1140. A value to be configured in the disk type 8304 is inputted in the disk type field 1141. A value to be configured in the RAID level 8305 is inputted in the RAID level field 1142. A value to be configured in the disk size 8306 is inputted in the disk size field 1143. A value to be configured in the number of drives in pool 8307 is inputted in the number of drives in pool field 1144.

When the OK button 1150 is pressed in accordance with an input by the administrator, the administrator computer 600 is configured to close the storage profile input screen and to send the information that has been inputted in the fields of the storage profile input screen to the management server 700 as the storage profile. The profile definer 930 is configured to register the received storage profile in the storage profile information 830. When the cancel button 1160 is pressed in accordance with an input by the administrator, the administrator computer 600 is configured to close the storage profile input screen and to discard the information that has been inputted in the fields of the storage profile input screen.

According to the storage profile input screen described above, the profile definer 930 is configured to be able to register in the storage profile information 830 a value input by the administrator.

The profile definer 930 is configured to display a service profile input screen on the administrator computer 600 in response to a request from the administrator computer 600.

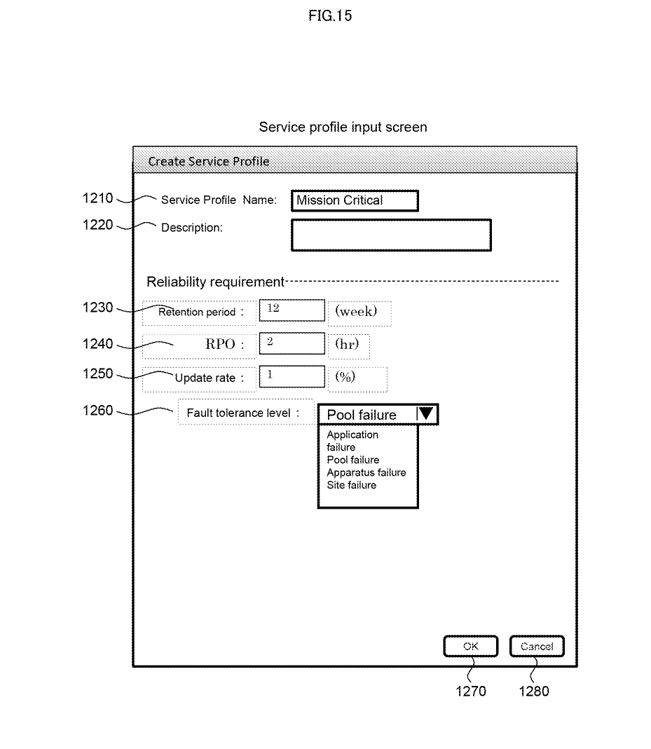

FIG. 15 shows the service profile input screen.

The service profile input screen includes a service profile name field 1210, a description field 1220, a retention period field 1230, a RPO field 1240, an update rate field 1250, a fault tolerance level field 1260, an OK button 1270, and a cancel button 1280.

A value to be configured in the service profile name 8401 is inputted in the service profile name field 1210. A value to be configured in the description 8402 is inputted in the description field 1220. A value to be configured in the retention period 8403 is inputted in the retention period field 1230. A value to be configured in the RPO 8404 is inputted in the RPO field 1240. A value to be configured in the update rate 8405 is inputted in the update rate field 1250. A plurality of preconfigured value candidates are displayed, and one value is selected from among the plurality of value candidates and inputted in the fault tolerance level field 1260 as the value to be configured in the fault tolerance level 8406.

When the OK button 1270 is pressed an accordance with an input by the administrator, the administrator computer 600 is configured to close the service profile input screen, and send the information that has been inputted in the fields of the service profile input screen to the management server 700 as the service profile. The profile definer 930 is configured to register the received service profile in the service profile information 840. When the cancel button 1280 is pressed in accordance with an input by the administrator, the administrator computer 600 is configured to close the service profile input screen and to discard the information that has been inputted in the fields of the service profile input screen.

According to the service profile input screen described above, the profile definer 930 is configured to be able to register in the service profile information 840 a value input by the administrator.

The provisioning executor 940 is configured to display a provisioning request screen on the administrator computer 600 in response to a request from the administrator computer 600.

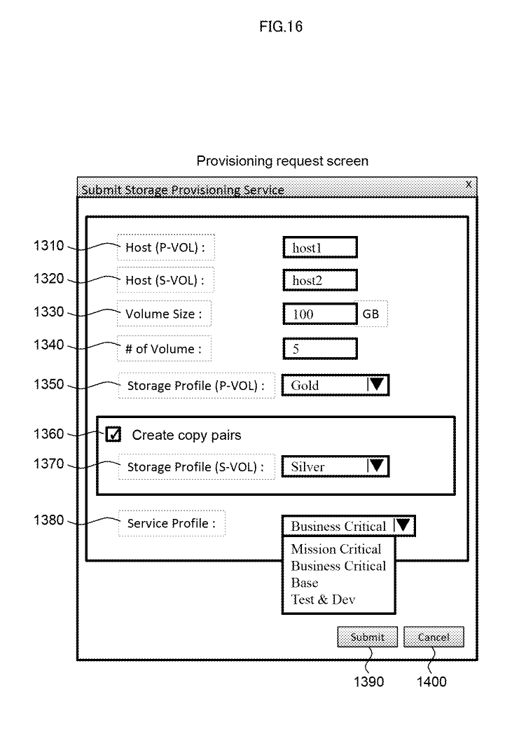

FIG. 16 shows the provisioning request screen.

The provisioning request screen includes a P-VOL host field 1310, an S-VOL host field 1320, a volume size field 1330, a number of volumes field 1340, a P-VOL storage profile field 1350, a copy pair field 1360, an S-VOL storage profile field 1370, a service profile field 1380, a submit button 1390, and a cancel button 1400.

A value to be configured in the P-VOL host 8603 is inputted in the P-VOL host field 1310. A value to be configured in the S-VOL host 8604 is inputted in the S-VOL host field 1320. A volume size is inputted in the volume size field 1330. A number of volumes is inputted in the number of volumes field 1340. A plurality of storage profile name 8301 values in the storage profile information 830 are displayed, and one of the plurality of values is selected in the P-VOL storage profile field 1350. The value selected in the P-VOL storage profile field 1350 shows the P-VOL storage profile. The storage profile name showing the P-VOL storage profile is inputted. True or false is inputted in the copy pair field 1360. A case where the copy pair field 1360 is true shows that a replication will be performed, and the S-VOL storage profile field 1370 becomes valid. A plurality of storage profile name 8301 values in the storage profile information 830 are displayed, and one of the plurality of values is selected in the S-VOL storage profile field 1370. The value selected in the S-VOL storage profile field 1370 shows the S-VOL storage profile. A plurality of service profile name 8401 values in the service profile information 840 are displayed, and one of the plurality of values is selected in the service profile field 1380.

When the Submit button 1390 is pressed in accordance with an input by the administrator, the administrator computer 600 is configured to close the provisioning request screen, and to send the information that has been inputted in the fields of the provisioning request screen to the management server 700 as a provisioning request. The provisioning executor 940 is configured to execute the provisioning process described hereinabove upon receiving the provisioning request from the administrator computer 600. When the cancel button 1280 is pressed in accordance with an input by the administrator, the administrator computer 600 is configured to close the provisioning request screen, and to discard the values that had been inputted in the fields of the provisioning request screen.

According to the provisioning request screen described above, the provisioning executor 940 is configured to be able to acquire as a provisioning request a storage profile and a service profile inputted by the administrator. The administrator can specify a provisioning request without being aware of the physical characteristics of each pool.

The effects of the present example will be explained below using a number of specific examples.

A first specific example concerns a first replication configuration candidate using only TI and a second replication configuration candidate using both TI and SI, and shows a case in which the cost of the second replication configuration candidate is lower than the cost of the first replication configuration candidate.

On the basis of a provisioning request, the retention period is configured to 4 [weeks], the RPO is configured to 2 [hours], the volume size is configured to 100 [GB}, and the update rate is configured to 1 [%/hour]. In the first replication configuration candidate, the number of TI generations becomes retention period/RPO=4×7×24 [hours]/2 [hours]=336 [generations], and the total replication capacity becomes 100 [GB]×1 [%/hour]×2 [hours]×336 [generations]=672 [GB]. Meanwhile, in the second replication configuration candidate, in accordance with i_min, the TI retention period becomes 1 [week], and the SI retention period becomes 3 [weeks]. Thus, the TI interval becomes 2 [hours], the SI interval becomes 1 [week], the number of TI generations becomes TI retention period=TI interval=1×7×24÷2=84 [generations], the number of SI generations becomes retention period SI interval −1=4÷1−1=3 [generations], and the total replication capacity becomes total TI capacity+total SI capacity=168 [GB]+300 [GB]=468 [GB].

A second specific example concerns a first replication configuration candidate using only TI and a second replication configuration candidate using both TI and SI, and shows a case in which the first replication configuration candidate cannot be realized due to the number of generations of the first replication configuration candidate exceeding the upper limit.

The preconfigured upper limit for the number of generations is 1024. On the basis of a provisioning request, the retention period is configured to 16 [weeks], the RPO is configured to 2 [hours], the volume size is configured to 100 [GB], and the update rate is configured to 1 [%/hour]. In the first replication configuration candidate, the number of TI generations becomes retention period/RPO=16×7×24 [hours]/2 [hours]=1344 [generations]. Because this number of TI generations exceeds the upper limit, the first replication configuration candidate cannot be realized. Meanwhile, in the second replication configuration candidate, in accordance with i_min, the TI retention period becomes 4 [weeks], and the SI retention period becomes 12 [weeks]. Thus, the TI interval becomes 2 [hours], the SI interval becomes 1 [week], the number of TI generations becomes TI retention period=TI interval=4×7×24÷2=336 [generations], the number of SI generations becomes retention period SI interval −1=16÷1−1=15 [generations], and the total replication capacity becomes total TI capacity+total SI capacity=162 [GB]+1500 [GB]=1662 [GB]. The second replication configuration candidate is realizable since the number of TI generations does not exceed the upper limit.

According to the present example, a volume requirement input for a service is received, a replication configuration is determined on the basis of cost, and the replication configuration is provisioned. The cost of a replication configuration candidate using only TI and the cost of a replication configuration candidate using both TI and SI are computed for requirements showing the retention period and the RPO in terms of reliability, and when the cost of the replication configuration candidate using both TI and SI is lower, the replication configuration candidate using both TI and SI is determined as the replication configuration. In the cost computation, the replication configuration may be determined using the difference between the upper limit values for the number of TI generations, or the specification of the storage apparatuses 100 (the upper limit values and copy types that are supported, etc.). The replication configuration is not limited to a local copy using either TI or SI, but rather may combine a remote copy (synchronous or asynchronous).

Furthermore, the storage apparatus 100, management system 200, and server 300 explained hereinabove do not need to be individual apparatuses or dedicated apparatuses. For example, when a processing module provided with a CPU and a storage resource is configured to execute a program (called a storage program) for performing the processing of the storage apparatus described above, this processing module becomes the controller 110. Similarly, when the processing module is installed with the management programs, this processing module becomes the management system 200. Similarly, when the processing module is installed with a program for issuing I/O requests, this processing module becomes the server 300. In addition, in accordance with a hypervisor or the like, a plurality of virtual processing modules may exist in a single computer, each of the virtual processing modules may execute the programs described above, and virtual processing modules like this may be distributed among and exist in a plurality of computers. The computers include a CPU and a storage resource. The processing module or computer that executes the storage program is coupled either directly or indirectly to the disks 120.

The terminology for expressing the present invention will be explained. The storage information may include the pool configuration information 810 and the pool load information 820.

A number of examples have been explained hereinabove, but these examples are illustrations for explaining the present invention, and the scope of the present invention is not limited solely to these examples. The present invention can also be implemented in a variety of other modes.

### REFERENCE SIGNS LIST

100 Storage apparatus

110 Controller

120 Disk

130 Pool

140 Volume

200 Management system

300 Server

510 Management network

520 Storage network

600 Administrator computer

700 Management server

1. A computer system comprising:
a storage device;
a first processing module that is coupled to the storage device, and that is configured to process I/O to/from the storage device;
a second processing module that is configured to issue a request for the I/O to the first processing module; and
a third processing module that is coupled to the first processing module,
wherein the first processing module is configured to create a logical storage area using a storage area in the storage device, the third processing module is configured to store storage information showing the configuration of the logical storage area, acquire a provisioning request that includes a reliability requirement related to reliability of a storage service provided to the second processing module from the first processing module, and a volume requirement related to a primary volume provided to the second processing module by the storage service, determine, on the basis of the volume requirement and the storage information, volume configuration information showing the configuration of a primary volume to be provisioned from the logical storage area, determine, on the basis of the volume configuration information, the reliability requirement, and the storage information, replication configuration information showing the configuration of a replication having the primary volume as a copy source, and send the volume configuration information and the replication configuration information to the first processing module, and
the first processing module is configured to provision the primary volume from the logical storage area on the basis of the volume configuration information, and to execute the replication on the basis of the replication configuration information.

2. The computer system according to claim 1, wherein the logical storage area is a plurality of pools,
the volume requirement shows a size of the primary volume, and the third processing module is configured to select a first pool from among the plurality of pools on the basis of the volume requirement and the storage information, and to include in the volume configuration information a feature of creating the primary volume from the first pool.

3. The computer system according to claim 2, wherein
the reliability requirement includes time information showing a time used in the replication of the primary volume, and update quantity information showing an update quantity of the primary volume within a predetermined unit of time, and
the third processing module is configured to determine, on the basis of the volume configuration information and the reliability requirement, snapshot configuration information showing the configuration of a snapshot of the primary volume, select from among the plurality of pools a second pool for the snapshot on the basis of the snapshot configuration information and the storage information, and include in the replication configuration information a feature of creating a snapshot volume for the snapshot is created from the second pool, and executing the snapshot from the primary volume to the snapshot volume.

4. The computer system according to claim 3, wherein the third processing module is configured to calculate, on the basis of the storage information, for each pool of the plurality of pools, a virtual capacity, which is a total of capacities of volumes associated with the pools, and to select the second pool from among the plurality of pools on the basis of the virtual capacity.

5. The computer system according to claim 1, wherein the third processing module is configured to determine, on the basis of the volume configuration information and the reliability requirement, at least either snapshot configuration information showing the configuration of a snapshot of the primary volume, or cloning configuration information showing the configuration of a cloning of the primary volume, and to include the determined information in the replication configuration information.

6. The computer system according to claim 5, wherein the reliability requirement includes time information showing a time used in the replication of the primary volume, and update quantity information showing an update quantity of the primary volume within a predetermined unit of time, and
the third processing module is configured to determine, on the basis of the reliability requirement, the number of snapshot generations and the number of cloning generations under a condition in which a total of a capacity required for the snapshot and a capacity required for the cloning is minimized.

7. The computer system according to claim 5, wherein the third processing module is configured to determine the snapshot configuration information and the cloning configuration information under a condition in which the number of snapshot generations becomes equal to or less than an upper limit preconfigured in the first processing module.

8. The computer system according to claim 5, wherein the third processing module is configured to store, for respective types of the first processing module, a restriction on either the upper limit for the number of snapshot generations preconfigured for the respective types, or a type of the replication supported by the respective types, and
the third processing module is configured to include in the replication configuration information at least either the snapshot configuration information or the cloning configuration information on the basis of the volume configuration information, the reliability requirement, and the restriction corresponding to the type of the first processing module.

9. The computer system according to claim 5, wherein the logical storage area is a plurality of pools,
the volume requirement shows a size of the primary volume, the third processing module is configured to select a first pool from among the plurality of pools on the basis of the volume requirement and the storage information, and to include in the volume configuration information a feature of creating the primary volume is created from the first pool, and
when the replication configuration information includes the snapshot configuration information and the cloning configuration information, the third processing module is configured to select, from among the plurality of pools, a second pool for the snapshot on the basis of the snapshot configuration information and the storage information, select, from among the plurality of pools, a third pool for the cloning on the basis of the cloning configuration information and the storage information, and include in the replication configuration information a feature of creating a snapshot volume for the snapshot from the second pool, creating a cloned volume for the cloning from the third pool, executing the snapshot to the snapshot volume from the primary volume, and executing the cloning to the cloned volume from the primary volume.

10. The computer system according to claim 9, wherein the third processing module is configured to calculate, on the basis of the storage information, for each pool of the plurality of pools, a virtual capacity, which is a total of capacities of volumes associated with the pools, and to select the third pool from among the plurality of pools on the basis of the virtual capacity.

11. The computer system according to claim 10, wherein
the third processing module is configured to indicate to the first processing module to create, as a replication copy-destination volume, either the copy-destination volumes for all generations shown in the replication configuration information, or the copy-destination volume for each generation, and
the third processing module is configured to calculate, for each pool of the plurality of pools, a virtual capacity, which is a total of capacities of volumes created from the pools, and on the basis of the virtual capacity, to select, from among the plurality of pools, a pool to be used for the copy-destination volume.

12. The computer system according to claim 1, wherein the third processing module is configured to acquire application characteristics of an application that is executed by the second processing module and that uses the storage service, create, on the basis of the application characteristics, a performance requirement for the performance of the storage service, and determine the volume configuration information on the basis of the storage information and the performance requirement.

13. A management program that is configured to cause a computer to execute a process for managing a first processing module that is coupled to a storage device, and that is configured to process I/O to/from the storage device,
the management program being configured to cause the computer to:
operate the first processing module to store, in accordance with creation of a logical storage area using a storage area in the storage device, storage information showing the configuration of the logical storage area;
acquire a provisioning request that includes a reliability requirement related to reliability of a storage service provided from the first processing module to a second processing module that issues a request for the I/O to the first processing module, and a volume requirement related to a primary volume provided to the second processing module by the storage service;
determine, on the basis of the volume requirement and the storage information, volume configuration information showing the configuration of a primary volume to be provisioned from the logical storage area;
determine, on the basis of the volume configuration information, the reliability requirement, and the storage information, replication configuration information showing the configuration of a replication having the primary volume as a copy source; and
send the volume configuration information and the replication configuration information to the first processing module, thereby causing the first processing module to provision the primary volume from the logical storage area on the basis of the volume configuration information, and to execute the replication on the basis of the replication configuration information.
